(19) United States
(12) Patent Application Publication
(10) Pub. No.: US 2011/0034217 A1
(43) Pub. Date: Feb. 10, 2011

(54) DEVICE FOR MOUNTING COMMUNICATION HEADSET TO SPORTS HELMETS AND THE LIKE

(75) Inventor: Abraham Kushnirov, Or-Yehuda (IL)

Correspondence Address: Leason Ellis LLP, 81 Main Street, Suite 503, White Plains, NY, 10601, US

(73) Assignee: Cardo Systems, Inc., Pittsburgh, PA (US)

(21) Appl. No.: 12/535,988

(22) Filed: Aug. 5, 2009

(51) Int. Cl. H04M 1/00; H04R 1/00

(52) U.S. Cl. 455/569.1; 381/376

(57) ABSTRACT

Device for mounting a communication headset to helmets of the type having a first strap extending in front of an ear of a user, a second strap extending behind the ear, and a chin strap connectable to the first and second straps, for instance, sports helmets. The device includes a mounting panel having a seat that includes a set of electrical contacts and a guide. A printed circuit board is in electrical connection with the electrical contacts. First and second legs are slideably movable along the guide. First and second clasps are pivotally mounted to a respective leg. In a further aspect of the inventions, one or more speakers can be in conductive contact with the printed circuit board. In still a further aspect of the invention, a remote assembly is in conductive electrical contact with the mounting device to provide audio signals to a second ear of the user.

### FIELD OF THE INVENTION

The present invention relates to improvements in portable communication devices and more particularly to a device for mounting a communication headset.

### BACKGROUND OF THE INVENTION

Today there is a vast array of sports helmets available to a user. Helmets are widely used to enhance the safety of persons riding vehicles such as a bicycle, a motorcycle, a water scooter, a snowmobile and so on. With broader usage of helmets it is desirable for a wearer of a helmet to be able to communicate with other individuals, listen to music, GPS audio commands, and other types of audio signals. It is becoming more popular to use mobile devices to communicate with other users while engaging in activities that include wearing a helmet. However, this is attendant with safety issues, particularly when the user holds the communication device in one hand. Using hands for two different purposes at the same time can distract and lead to accidents. Yet it is desirable for a user wearing a helmet to use electronic devices that have audio signal for the user to hear.

Therefore, it would be desirable to have a communication headset attachable to a helmet in an easy to attach and remove manner. It would be further desirable to provide a mount for such a communication headset that attaches to conventional sports and head protection helmets. The present invention addresses these and other needs.

### SUMMARY OF THE INVENTION

According to one aspect of the invention, a device is provided for mounting a communication headset to a helmet of the type having a first strap extending in front of an ear of a user, a second strap extending behind the ear, and a chin strap connectable to the first and second straps. The device includes a mounting panel having a seat that includes a set of electrical contacts and a guide. A printed circuit board is in electrical connection with the electrical contacts. First and second legs are each slideably movable along the guide. First and second clasps are pivotally mounted to a respective leg.

In a further aspect of the inventions, one or more speakers can be in conductive contact with the printed circuit board.

In still a further aspect of the invention, a remote assembly is in conductive electrical contact with the mounting device to provide audio signals to a second ear of the user.

These and other aspects, features and advantages of the invention can be further appreciated from the accompanying drawing figures and description of certain embodiments of the invention.

### BRIEF DESCRIPTION OF THE DRAWINGS

FIG. 1 illustrates an example of a prior art sports helmet to which a communication headset can be mounted in accordance with an aspect of the invention.

FIG. 2 illustrates a schematic diagram of a sports helmet having a communication headset seated on a mounting device in accordance with one embodiment of the invention.

FIG. 3 illustrates the mounting device of FIG. 2.

FIG. 4 illustrates a rearview of a partially disassembled mounting device of FIG. 2 in order to illustrate certain features thereof.

FIG. 5 illustrates another embodiment of the mounting device in which an accessory mounting device is electrically connected to the mounting device of FIGS. 2-4.

FIG. 6 illustrates a sports helmet strap along with yet another embodiment of a mounting device for supporting a communication headset;

FIG. 7 is a partial, closeup rear view of a portion of the mounting device of FIG. 6;

FIG. 8 is a rear partial view of a sports helmet and strap along with a mounting device in accordance with a different embodiment of the present invention;

FIG. 9 is a partial, closeup rear view of a portion of the mounting device of FIG. 8; and

FIG. 10 is a side elevation view of a portion of the mounting device of FIG. 8 showing coupling to the strap of the sports helmet.

### DETAILED DESCRIPTION OF CERTAIN EMBODIMENTS OF THE INVENTION

Embodiments of the invention described herein are generally directed to a mounting device configured to attach to a helmet. FIG. 1 illustrates an example of a prior art sports helmet 100 having a hard shell 102 that can be placed on a user's head. The shell 102 includes a first strap 104 extending in front of an ear of the user and a second strap 106 extending behind the ear. A chin strap 108 extends from one side of the shell to other, and is connectable to a free end 110 that joins the first 104 and second straps 106 at a Y-connector 112 to secure the helmet to the head of the user. The straps act as a harness to secure the shell 102 while padding 114 rests between the shell and the user's head to accommodate a range of head sizes.

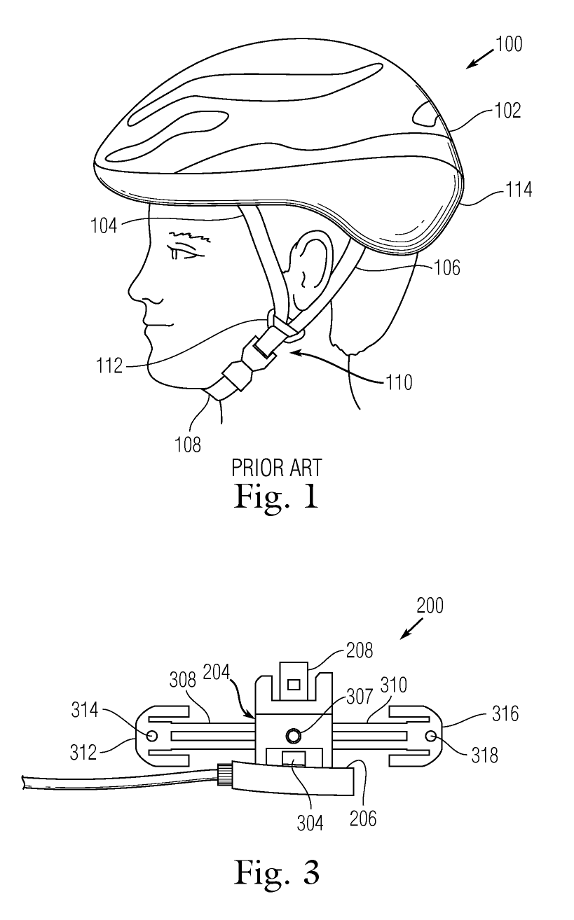

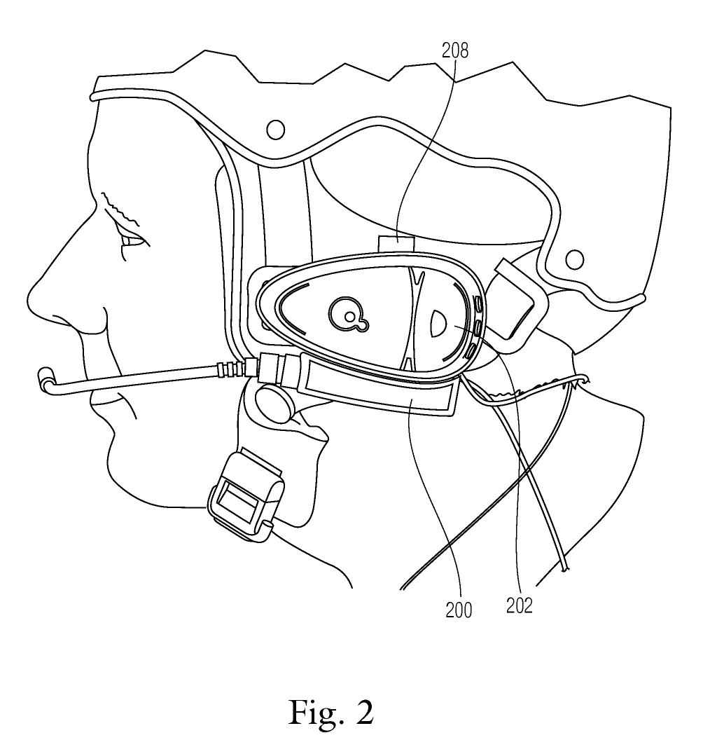

Turning now to FIGS. 2 and 3 a communication headset 202 is shown mounted on the sports helmet 100 by way of a mounting device 200 in accordance with a first embodiment of the invention. The mounting device 200 generally has a mounting panel 204, a guide 306, legs 308, 310, clasps 312, 314 and is arranged to receive a communication headset 202. The communication headset 202 is an electric device configured to provide audible signals to the user's ear(s), and can take on a variety of forms such as a Bluetooth device or a cellular device or a music player. The communication headset 202 forms no part of the present invention. The communication headset 202 seats on the mounting device 200. The communication headset 202 can be unseated from the mounting panel 204 by pressing upon a tab 208. The tab 208 can be configured for manual depressible for movement clear of the communication headset 202 so as to release it from the snap-lock engagement. The communication headset 202 can have its own speakers, and if so, the speakers rest adjacent the user's ear when the mounting device 200 is attached to the y-straps 104, 106.

In FIG. 3 the communication headset 202 has been removed to show further details of the mounting device 200. The mounting panel 204 includes a seat 206 having a set of electrical contacts 304. The seat limits insertion of communication headset 202 and ensures that the electrical contacts engage corresponding contacts on a rear side of the communication headset. A mounting panel 204 extends from the seat 206 to fingers that are shaped to engage the communication headset 202 and snap-lock the communication headset to the mounting panel 204.

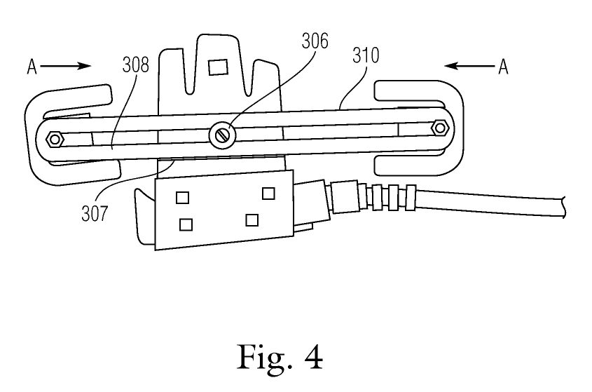

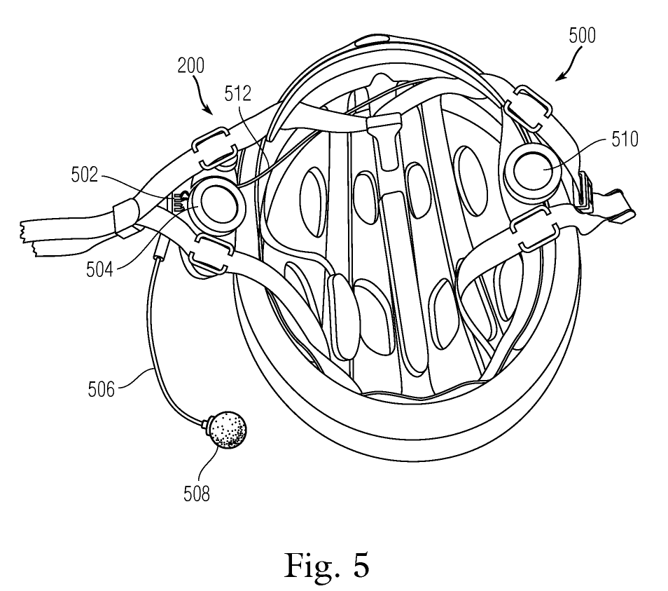

Referring now to FIGS. 3 and 4, first and second legs 308, 310 each are slideably movable relative to the mounting panel 204. Movement of the legs is along a guide 306. The guide 306 limits the degree of freedom of movement of the first and second legs. In the arrangement as shown, the guide comprises a screw that extends through a slot in each of the first and second legs. The screw prevents the legs from separating from the mounting panel 204 and also limits movement of the legs. Instead of a screw, a rivet or a guide post can be used. Also, in the illustrated arrangement, an edge 307 abuts the legs and constrains slideable movement to be along a single horizontal plane. A guide in accordance with the invention is any structure that constrains movement of the legs relative to the mounting panel 204.

Each of the legs 308, 310 has an outer end to which a clasp is attached. A first clasp 312 is attached to the leg 308 at a first pivot 314. A second clasp 316 attached to the leg 310 at a second pivot 318. The first and second clasps 312, 316 are pivotally mounted so as to automatically adjust an angle of the first and second clasps relative to the straps 104, 106 as the legs are slid towards on another during mounting of the mounting device 200 to the helmet straps 104, 106. In the illustrated embodiment, the first and second clasps 312, 316 move independently of each other.

In use, the legs can be moved in the direction of arrows A (FIG. 4) to attach the mounting device 200 to the y-straps 104, 106. In a particular embodiment of the invention, the guide 306 further includes a locking mechanism to secure the first and second legs 308, 310 in a set position. The locking mechanism is desirable in certain embodiments because it can provide two states of operation. In a first state, the locking mechanism is released to permit sliding movement of the legs 308, 310 relative to each other. This permits the legs to slide and the clasps to engage the y-straps when the mounting device 200 is being attached to the helmet 100 and permits the legs to slide in an opposite direction for removal of the mounting device 200 from the straps. In a second state, the locking mechanism secures the legs 308, 310 against any sliding movement. In this state, the clasps can be held in position on the y-straps. Preferably, the locking mechanism is biased or otherwise normally in the second state.

The locking mechanism can be, but is not limited to, a screw, a ratchet, a push-pull button. For example, a ratchet type locking mechanism can be used. The ratchet consists of a gear arrangement or linear rack having teeth in operative association with a pivoting, spring-loaded finger (e.g. a pawl) that engages the teeth. Either the teeth or the pawl are slanted at an angle so that when the teeth are moving in one direction the pawl slides up and over each tooth, in turn, with the spring forcing it back with a ‘click’ into the depression before the next tooth. When the teeth are moving in the opposite direction, the angle of the pawl causes it to catch against a tooth and stop further motion in that direction. It will be appreciated that other locking mechanisms can be provided to control the movement of the legs 308, 310. As another example, the locking mechanism can comprise teeth provided on the legs to couple one leg to the other. The teeth on the legs can be aligned to limit the total movement of the legs. This arrangement can ensure that the legs both extend equally from the mounting panel 204 as either is slid in the direction of Arrow A or in the opposite direction.

A printed circuit board 502 is disposed within the mounting device 200, as can be seen in FIG. 5. The printed circuit board 502 has tracing in electrical connection with the electrical contacts 304 of the seat 206. A speaker 504 is in, or can be placed into, conductive contact with the printed circuit board 502. As such, the speaker 504 is or can be communicatively coupled to the communication headset 202 when the headset 202 is seated in the mounting panel 204.

The mounting device 200 has a boom 506 extending from the mounting panel 204 microphone 508 is mounted to a free end of the boom 506 and wires within the boom connect the microphone to the set of contacts 304, directly or by way of the printed circuit board 502.

As shown in FIG. 5, a slave device 500 can connect to the mounting device 200. The slave device 500 comprises a second mounting device constructed so as to have the guide 306, legs 308, 310, and clasps 312, 314. The second mounting device does not require a seat to receive the communication device 202 or the contacts 304, or the printed circuit board 502. Instead, it can be wired or wirelessly connected to the mounting device 200 to provide audio signals to a second ear of the user, e.g. via a speaker 510.

In an embodiment of the invention, a wire 512 connects the speaker 510 to the circuit board 502 or the electrical contacts 304. In one arrangement, the connection can be a wireless connection, such as Bluetooth, infrared and the like.

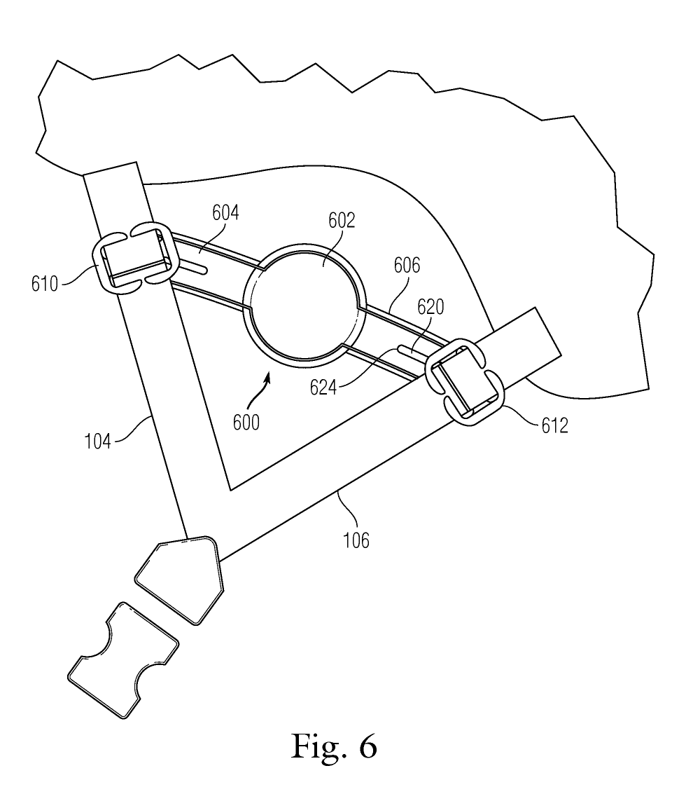

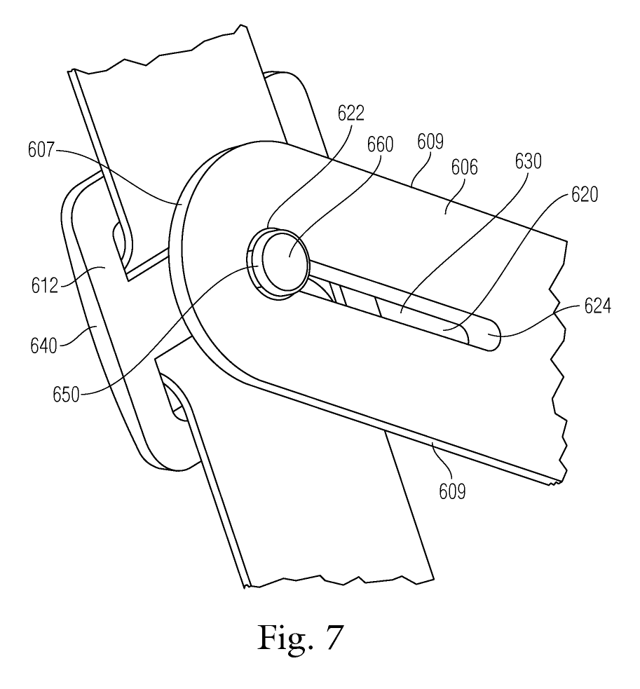

Now turning to FIGS. 6 and 7 in which a mounting device 600 according to yet another embodiment of the present invention is shown. As with the other mounting devices disclosed herein, the mounting device 600 generally has a mounting panel 602, legs 604, 606, clasps 610, 612 and is arranged to receive the communication headset 202 shown and described with reference to FIG. 2, and to support the speaker 504 or 510 (not shown). As previously mentioned, the communication headset 202 seats on the mounting device 200.

In this embodiment and unlike in previous embodiments, the legs 604, 606 are fixed relative to the centrally located mounting panel 604. In other words, the legs 604, 606 do not move relative to the mounting panel 602 but rather extend radially outward from the central portion 602 and away from the communication headset 202 and speaker 504, 510. In the illustrated embodiment, the distal ends 607 of the legs 604, 606 have a rounded shape. The legs 604, 606 can thus be integrally formed with the central mounting panel 602 (e.g., a common molding process).

Each leg 604, 606 has an elongated slot 620 (guide slot) formed therein along a length thereof. The slot 620 has a first end 622 and a second end 624 with the first end 622 being formed closer to the rounded distal end 607. In other words, the first end 622 of the slot 620 is located proximate the distal end 607. The first end 622 of the slot 620 has an enlarged profile relative to the profile of the rest of the slot 620. More specifically, the first end 622 of the slot 620 has a circular shape that has a diameter that is greater than a main portion 630 of the slot 620 that extends to and terminates at the second end 624. The second end 624 can have a rounded shape. Between the circular shaped first end 622 and the main portion 630, a neck (not shown) of reduced diameter (width) is formed so as to define a reduced diameter entrance into the main portion 630. The second end 624 is spaced from the central mounting portion 602. An axis that extends along the length of the elongated slot 620 is parallel to the two side edges 609 of the respective leg 604, 606.

The clasp 610, 612 is similar or identical in function to the clasps disclosed hereinbefore in that the first and second clasps 610, 612 are movably mounted so as to automatically adjust an angle of the first and second clasps 610, 612 relative to the straps 104, 106 during mounting of the mounting device 600 to the helmet straps 104, 106. In the illustrated embodiment, the first and second clasps 610, 612 move independently of each other.

Each clasp 610, 612 is designed to interlockingly (couplingly) mate with the respective leg 604, 606, while still having multiple degrees of freedom of movement. As shown, each clasp 610, 612 has a top portion 640 and a post 650 that is attached thereto and extends outwardly therefrom. The top portion 640 has one or more finger structures 642 that are designed to grasp the straps 104, 106. The clasp is mated to the strap 104, 106 by engaging the fingers 642 with the strap 104, 106 to cause the clasp to be held on the strap. The post 650 terminates in a distal end 652 that includes a coupling flange 660. The coupling flange 660 has an annular shape that has a diameter that is greater than a diameter of the post 650. A shoulder is thus formed between the post 650 and the flange 660. The diameter of the flange 660 is preferably slightly larger than the circular shaped opening at the end 622 of the slot 620.

In accordance with the present invention, each of the claps 610, 612 has at least two degrees of freedom. One will appreciate that each clasp 610, 612 has two degrees of motion relative to its respective leg 604, 606. More specifically, the clasp pivots (rotates) relative to the leg and the clasp can likewise move linearly along and within the guide slot 620. In particular, the clasp is mated to the respective leg by first inserting the coupling flange 660 into the circular shaped opening at the distal end 622 of the guide slot 620. The clasp 610, 612 is then moved into the main portion 630 of the slot 620 by being passed through the neck. Since the leg can be formed of a plastic material and the post can likewise be a plastic material, there is some degree of flexing of the components which allows the post 650 to pass through the neck. Once the post 650 clears the neck, the neck returns to a normal (rest position) which prevents the free movement of the post 650 back into the circular shaped opening at the distal end 622. Once in the main portion 630 of the slot 620, the clasp can move linearly along a length of the respective leg. At the same time, the complementary nature of the post 650 and the slot 620 allows the clasp to freely pivot (rotate) therein. The enlarged nature of the flange relative to the main portion 630 of the slot 620.

The detachable mechanical fit between the clasp and the respective leg can be characterized as being a snap-fit fit. The specific structure and shape of the clasp 610, 612 can be varied and therefore, it will be appreciated that the clasp 610, 612 merely illustrates one design for the clasp however other shapes and designs (e.g., circular, etc.) are equally possible. As shown in FIGS. 6 and 7, the majority of the mounting member 600 is disposed along the inner surfaces of the straps (i.e., the faces of the straps that face inwardly toward the wearer's head). The fingers of the clasp are disposed along the opposite outer surfaces of the straps.

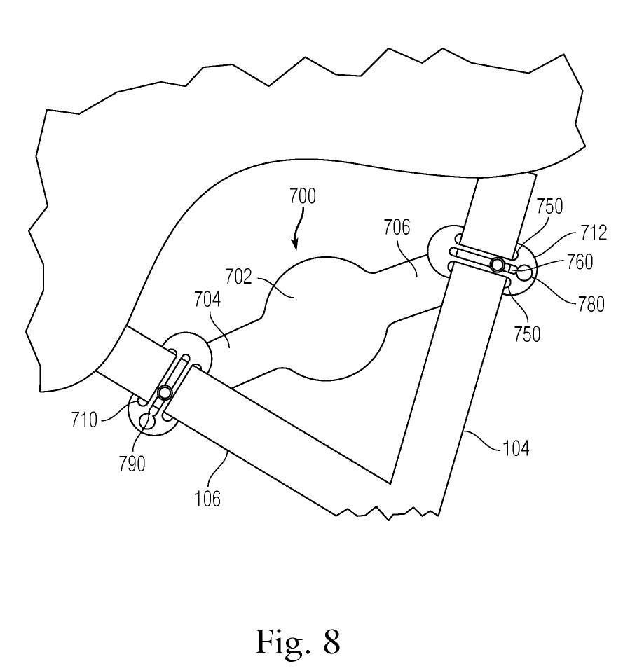

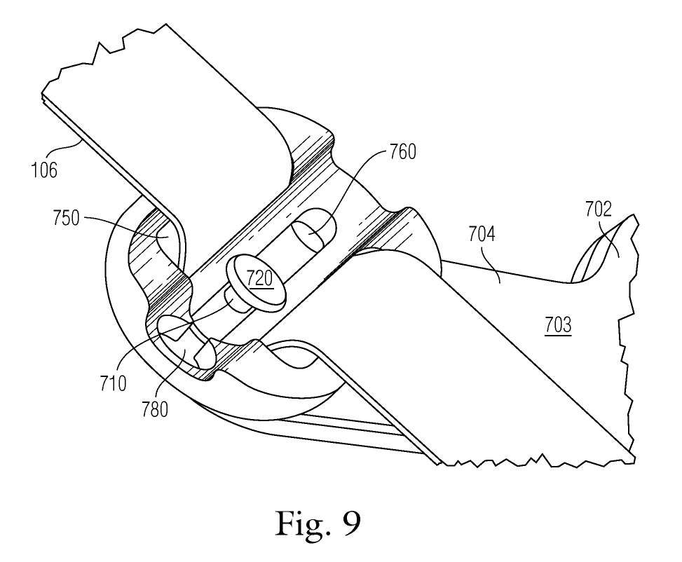

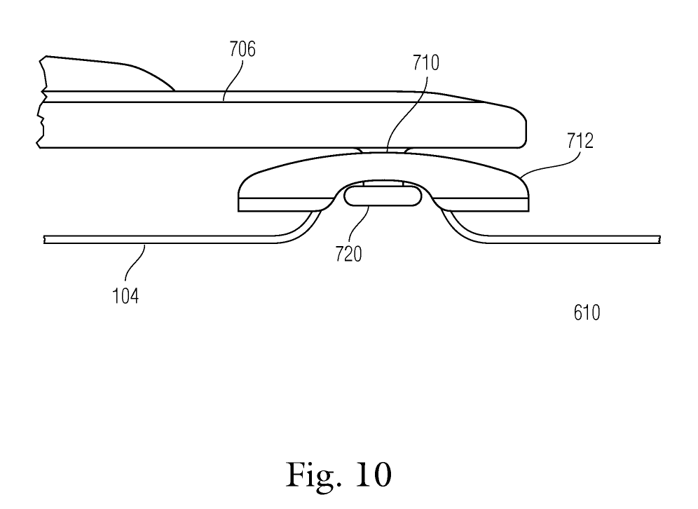

Now turning to FIGS. 8-10 in which a mounting device 700 according to yet another embodiment of the present invention is shown. The mounting device 700 is similar to the device 600 and generally has a mounting panel 702, legs 704, 706, clasps 710, 712 and is arranged to receive the communication headset 202 of the type shown and described with reference to FIG. 2. In FIG. 8, an inner surface of the mounting device 700 is illustrated which includes apertures on the rear of the mounting panel 702 through which sound from an internal speaker can emit. One of the main differences between the device 700 and the device 600 is the location of the device after attachment to the straps of the helmet. Opposite to the device 600, the mounting device 700 is designed to be disposed along the outer surfaces of the straps (i.e., the faces of the straps that face outwardly away from the wearer's head.

In this embodiment, the mounting panel 702 and the legs 704, 706 are formed as a single, integral structure (e.g., a molded plastic structure). As shown, the mounting panel 702 can have a circular shape, while the legs 704, 706 have an elongated shape with the ends of the legs 704, 706 being rounded. Unlike the previous embodiment, each leg 704, 706 includes an integral post or pin 710 that is formed along and extends outwardly from an inner surface or face 703 of the device 700. The pin 710 is formed proximate the distal end of the respective leg 704, 706 and in the illustrated embodiment, the pin 710 has a circular shape (e.g., cylindrical shaped pin) that has a coupling flange 720 formed at a distal end thereof. The flange 720 has a circular shape and has a diameter that is greater than a diameter of the main body of the pin 710. As a result, the flange 720 extends outwardly from an outer surface of the main body of the pin 710. The peripheral edge of the flange 720 can have a rounded edge.

The device 700 thus has two pins 710 that are axially aligned with one another along the length of the device 700 and preferably, the pins 710 are centrally located relative to a width of the legs 704, 706.

In this embodiment, each clasp 704, 706 is formed of a body (plastic body) that includes a first pair of slots 750 and a central slot 760. The slots 750, 760 are elongated slots that extend the length of the clasp 704, 706. The central slot 760 is located between the slots 750 and is preferably centrally located within the body of the device 700. In other words, the pair of slots 750 is formed on each side of the central slot 760.

The slots 750 can be identical to one another and are constructed to receive and retain the straps 104, 106. The width of the straps 104, 106 are slightly less than the length of the slots 750 and therefore, the straps 104, 106 are permitted some movement within the slots 750. The width of the slots 750 is similarly constructed to receive the straps 104, 106 (e.g., the thickness of the straps 104, 106 is less than the width of the slot 750).

It will be appreciated that in this embodiment, the clasps 710, 712 can have openings, such as slots or slits, (not shown) to permit the straps 104, 106 to be received therein. For example, one end of the slot 750 can have an opening (slit) that permits receive one strap 104, 106, thereby allowing the straps 104, 106 to be engaged with the clasps 710, 712.

The central slot 760 has a different construction compared to the slots 750 as shown. More specifically, the central slot 760 has a greater length than the length of the slots 750 and at one end of the central slot 760, a receiving opening 780 is formed. The receiving opening 780 has increased dimensions relative to a main portion of the central slot 760. In particular, the receiving opening 780 can be in the form of a circular opening that is formed at the end of the elongated main portion of the slot 760 (in use the receiving opening 780 is located on the outside of the straps 104, 106). A diameter of the receiving opening 780 is selected to allow the flange 720 of the pin 710 to be received therein. Between the receiving opening 780 and the main portion of the central slot 760, a neck 790 is formed. The neck 790 has reduced dimensions relative to the opening 780 and the main portion of the central slot 760 and relative to the diameter of the main portion of the pin 710. The body of the clasps and the pin are formed of materials that permit some flexing and therefore, once the flange 720 is received within the opening 780 and advanced so that the pin body 710 is disposed adjacent the neck 790, the pin 710 can be advanced into the main portion of the central slot 760 by clearing the neck 790 (which flexes slightly). Thus, a snap-fit arrangement can result between the pin and the clasp.

As with the previous embodiment, the pin and groove arrangement of device 700 allows the clasp 710, 712 to move linearly with respect to the device 700 and further, the clasp can pivot (rotate) about the pin 710.

As shown, the straps are routed through the slots 750. In addition, the main pin body 710 passes through the strap 104, 106 as by an opening formed through the strap 104, 106. As with the previous embodiment, the device 700 can be adjusted relative to the straps 104, 106 to ensure a proper fit.

The foregoing discussion of several embodiments is not intended to be restrictive but rather expansive of the permutations that can be had to implement the broad aspects of the present invention. In other words, features and parts of one embodiment can be used in connection with another embodiment.

While the invention has been described in connection with what are presently considered to be the most practical and various embodiments, it is to be understood that the invention is not to be limited to the disclosed embodiments, but on the contrary, is intended to cover various modifications and equivalent arrangements included within the spirit and scope of the appended claims.

We claim:

1. A device for mounting a communication headset to helmets of the type having a first strap extending in front of an ear of a user and a second strap extending behind the ear and a chin strap connectable to the first and second straps to secure the helmet to a head of the user, comprising:
a mounting panel having a seat that includes a set of electrical contacts and a guide;
a printed circuit board in electrical connection with the electrical contacts;
first and second legs each slideably movable along the guide; and
first and second clasps pivotally mounted to a respective leg.

2. The device of claim 1, wherein the first and second legs are slideably movable along the guide for independent movement relative to one another.

3. The device of claim 1, wherein the first and second clasps are pivotally mounted for independent movement relative to one another.

4. The device of claim 1, further comprising:
a boom mounted to the mounting panel, the boom having a free end; and
a microphone mounted to the free end of the boom.

5. The device of claim 1, wherein the mounting panel includes fingers shaped and positioned to snap-lock engage the communication headset to the mounting panel.

6. The device of claim 5, wherein the mounting panel further comprises a tab configured for manual depressable movement so as to release the communication headset from the snap-lock engagement.

7. The device of claim 1, further comprising:
a wire in conductively electrical contact with the set of electrical contacts and extending to a remote assembly, the remote assembly comprising:
a second mounting panel having a second guide, legs slideably moveable along the second guide and clasps pivotally mounted to respective legs.

8. The device of claim 7, further comprising a second speaker in conductive contact with the wire.

9. The device of claim 1, wherein the guide can be a housing to support the movement of the first and second legs.

10. The device of claim 1, is electrically connected to the printed circuit board.

11. The device of claim 1, further comprising a speaker in conductive contact with the printed circuit board.

12. The device of claim 1, further comprising teeth on the first and second legs, wherein the teeth the teeth of the first leg engages the teeth of the second leg so that first and second legs are coupled to one another.

13. A device for mounting a communication headset to helmets of the type having a first strap extending in front of an ear of a user and a second strap extending behind the ear and a chin strap connectable to the first and second straps to secure the helmet to a head of the user, comprising:
a mounting panel having a seat that includes a set of electrical contacts;
a printed circuit board in electrical connection with the electrical contacts;
first and second legs each extending outwardly from the mounting panel; and
first and second clasps coupled to a respective leg such that each clasp has at least two degrees of freedom relative to the leg.

14. The device of claim 13, wherein the first and second legs are integrally formed with the mounting panel and the two degrees of freedom include rotation and linear movement.

15. The device of claim 13, further comprising a speaker in conductive contact with the printed circuit board.

16. The device of claim 13, further comprising a wire in conductively electrical contact with the set of electrical contacts and extending to a remote assembly, the remote assembly comprising:
a second mounting panel having legs extending therefrom with each leg supporting a respective clasp coupled so as to have at least two degrees of freedom relative to the supporting leg; and a second speaker supported by the second mounting panel and being in conductive contact with the wire.

17. The device of claim 13, wherein each clasp rotates about a pivot and moves along a linear path with relative to the respective leg.

18. The device of claim 13, wherein each leg includes a guide slot formed therein and the clasp includes a pin that is received within the guide slot, wherein movement of the pin within the guide slot results in linear movement of the clasp along a length of the respective leg, the clasp being rotatably about the pin.

19. The device of claim 16, wherein the clasp includes flexible fingers that permit one strap to be securely coupled to the clasp by being removably received within slots defined by the fingers.

20. The device of claim 16, wherein one end of the guide slot includes an enlarged opening that receives a coupling flange that is formed at a free distal end of the pin, the flange having increased dimensions relative to a main portion of the pin.

21. The device of claim 13, wherein each leg includes a pin that extends outwardly from a face of the leg and the clasp includes a first guide slot that receives the pin, wherein movement of the pin within the first guide slot results in linear movement of the clasp along a length of the respective leg, the clasp being rotatably about the pin.

22. The device of claim 19, wherein the clasp further includes a pair of second slots formed on each side of the first guide slot, the second slots for receiving one strap of the helmet.
